(19) United States
(12) Patent Application Publication
(10) Pub. No.: US 2004/0118589 A1
(43) Pub. Date: Jun. 24, 2004

(54) Electrical conduit

(76) Inventors: Henri Pierrot, Dijon (FR); Christian Dupoux, Dijon (FR); Zine Bacha, Saverne (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/476,499

(22) PCT Filed: May 7, 2002
(86) PCT No.: PCT/FR02/01554

(30) Foreign Application Priority Data
May 11, 2001 (FR) 01/06347

(51) Int. Cl. H02G 5/00

(52) U.S. Cl. 174/68.2

(57) ABSTRACT

The invention relates to an electrical busbar for transportation and distribution of electrical power comprising several parallel, metal conducting bars spaced out from one another inside a metal enclosure, each conducting bar having a cross-section of elongate shape. At least one conducting bar is provided with a thickness near to the centre of the cross-section of said conducting bar that is greater than thickness of at least one of the ends of the cross-section of said conducting bar.

### BACKGROUND OF THE INVENTION

The present invention relates to an electrical busbar for transportation and distribution of electrical power composed of several, rigid, parallel, metal electrical conductors, spaced out from one another inside a metal enclosure, the shape of the conductors whereof enables the heat exchanges with the external environment through the metal enclosure to be optimized.

### STATE OF THE ART

Electrical power transportation/transmission and distribution systems via prefabricated electrical busbars or canalizations are well known. They serve the purpose on the one hand of transporting power from one point to another in an electrical installation, for example from one electrical switchboard to another electrical switchboard, and on the other hand of distributing this electrical power for the different receivers located along the busbar, proposing fixed, regularly spaced apart connection points. The receivers are then supplied by means of junction boxes connected to these connection points. Moreover fitting and removal of a junction box often has to be able to be performed easily without having to cut the electrical power supply of the busbars, by means of a plug-in type connection.

A first technology exists for achieving such a pre-fabricated electrical busbar wherein the parallel conductors of the busbar are insulated and pressed against one another in a metal enclosure. This first technology enables the reactance of the prefabricated electrical busbar to be reduced and achieves a better heat exchange with the outside in particular for high intensities, such as those greater than 1000 A. However, to achieve plug-in type connections, it becomes necessary to separate the conductors from one another at least over a part of the busbar. In a second technology, the parallel conductors are spaced apart from one another in the enclosure. This second technology increases the reactance of the electrical busbar and makes the heat exchange with the outside less efficient, however it does enable junction boxes to be fitted and removed much more easily by means of a plug-in type connection. It is therefore proposed to improve the heat exchange with the outside in electrical busbars comprising spaced apart conductors.

To optimise the heat exchange between the conductors and the outside environment and thus limit the temperature of the conductors, the heat exchange between the conductors and the metal enclosure of the busbar has to be optimised. This exchange takes place by convection but especially by radiation of the conductors. This radiation depends on the thermal emissivity of the surfaces of the emitting material (forming the conductors) and of the receiving material (forming the enclosure), and on the size of the surfaces of the materials, but also depends on a form factor between the conductors and the metal enclosure.

The form factor between two surfaces (or angle factor) defines the respective positioning of the two surfaces with respect to one another. The more the surfaces are facing one another, the better the form factor. The conductors of this type of electrical busbar usually have a substantially rectangular cross-section and are placed next to one another, their main faces facing one another. The form factor between the conductors and the metal enclosure is therefore very low, in particular for the external conductors which are not situated on the circumference.

### OBJECT OF THE INVENTION

The object of the invention is to modify the shape of the cross-section of the conductors to improve the form factor of these conductors with the enclosure and therefore the heat exchange between conductors and enclosure without penalising the overall size of the busbar (i.e. without increasing the distance between each conductor for example) and without increasing the cross-section of the conductors of the busbar, so as to be able to keep the same cabinets and the same enclosures.

For this, the invention describes an electrical transportation and distribution busbar comprising several rigid, parallel, metal conducting bars spaced out from one another inside a metal enclosure and separated from the metal enclosure, each conducting bar having an elongated cross-section with a first main face and a second main face. The cross-section of at least one conducting bar of said electrical busbar is provided with a thickness measured near to the centre of said cross-section that is greater than the thickness measured at at least one of the two ends of said cross-section.

According to a first feature, the cross-section of at least one conducting bar of the electrical busbar has a thickness near to the centre of said cross-section that is greater than the thicknesses of the two ends of said cross-section.

According to a second feature, the cross-section of at least one conducting bar of the electrical busbar has a thickness at a first end of said cross-section that is greater than a thickness at a second opposite end of said cross-section.

According to one feature, the cross-section of at least one conducting bar has a first main face comprising two enlarged V-shaped parts. According to another feature, the cross-section of at least one conducting bar has a first main face of convex shape.

According to another feature, the cross-section of at least one conducting bar has a symmetrical shape with respect to a transverse axis passing through the cross-section of said conducting bar in a direction parallel to the width of said conducting bar.

According to another feature, all the conducting bars of a busbar have a cross-section of identical shape.

### BRIEF DESCRIPTION OF THE DRAWINGS

Other features and advantages will become more clearly apparent from the following detailed description referring to embodiments given for example purposes only and represented by the accompanying drawings in which:

FIG. 1 represents a busbar comprising four conducting bars according to the prior art,

FIG. 2 represents a busbar comprising four conducting bars according to the present invention,

FIG. 3 shows different examples of cross-sections of conducting bars.

### DESCRIPTION OF PREFERRED EMBODIMENTS

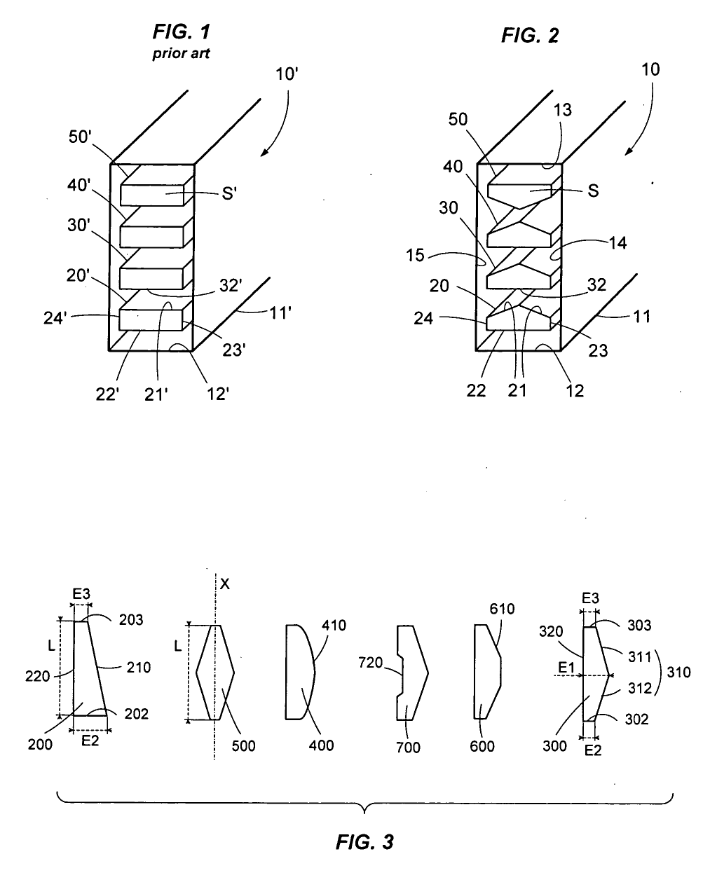

FIG. 1 represents a pre-fabricated electrical busbar 10′ according to the prior art comprising four conducting bars 20′,30′,40′,50′ in a closed metal enclosure 11′ of substantially rectangular straight cross-section. The four conducting bars are rigid, parallel, spaced out from one another and separated from the enclosure 11′. Usually, the straight transverse section S′ (hereinafter called the cross-section) of all these conducting bars is substantially rectangular and comprises, for example for the bar 20′, two straight and parallel, opposite main faces 21′,22′, situated between two opposite short faces 23′,24′, straight and perpendicular to the main faces. The rectangular shape of the cross-sections of the bars in such a busbar 10′ does not always enable an efficient heat exchange to be achieved between the conducting bars and the metal enclosure 11′ for the heat radiated by the bars when an electric current is flowing through the latter.

It is generally assumed that a large part of the heat generated by a conducting wall is radiated diffusely, that is to say in all directions. For the bar 20′, the heat given off and radiated by its main face 22′, situated facing the metal enclosure 11′, can easily be exchanged with the inside wall 12′ of the enclosure 11′ parallel to the main face 22′. The opposite main face 21′ of the bar 20′ is on the other hand situated directly facing the main face 32′ of the bar 30′ and it is therefore difficult for the heat radiated by the main face 21′ of the bar 20′ to be exchanged with the metal enclosure 11′ of the busbar. Likewise, as the two main faces of the bars 30′ and 40′ are not directly facing a wall of the metal enclosure 11′, it is difficult for them to exchange their radiated heat with the walls of the enclosure.

FIG. 2 represents a pre-fabricated electrical busbar 10 according to the invention comprising four conducting bars 20,30,40,50 in a metal enclosure 11. These conducting bars can for example carry a neutral N and three phases L1,L2,L3. The four conducting bars are rigid, parallel, spaced out from one another and separated from the enclosure 11. The enclosure has a straight cross-section of substantially rectangular shape comprising four inside walls 12,13,14,15—two parallel main walls 14,15 and two secondary walls 12,13, parallel and substantially orthogonal with the main walls 14,15. The cross-section S (straight cross-section) of the conducting bars 20,30,40,50 has a width L and a variable thickness E1,E2,E3 measured respectively near to the centre and at the two ends of the cross-section S. This cross-section S is of elongate shape and the value L of the width (see the different examples of FIG. 3) is therefore greater than the different values E1,E2,E3 of the thickness. The cross-section S comprises an opposite first main face 21 and second main face 22 situated between two opposite short faces, these faces preferably being smooth. The short faces of a conducting bar are flat or rounded and can be substantially parallel to the main walls 14,15 of the enclosure, as in the example of FIG. 2. In FIG. 2, two external bars 20,50, one of the main faces whereof is facing a secondary wall 12,13 of the enclosure, frame one or more intermediate bars 30,40, the two main faces whereof are facing a main face of another bar.

The object of the invention is to increase the form factor between at least one main face of one or more conducting bars 20,30,40,50 and at least one internal main wall 14,15 of the metal enclosure 11, so as to improve the heat exchange between the conducting bars and the metal enclosure of the busbar. This object is achieved by modifying the rectangular shape of the prior art of the cross-section S′ of at least one conducting bar. According to the invention, the cross-section S of at least one conducting bar 20,30,40,50 of the electrical busbar 10 in fact has a thickness E1 near to the centre of the cross-section S that is greater than the thickness E2,E3 of at least one of the ends of the cross-section S. The different examples of FIG. 3 show several embodiments of the invention.

According to a first preferred embodiment, the thickness E1, measured near to the centre of the cross-section of a conducting bar 300, is greater than the thicknesses E2, respectively E3, measured at the ends 302, respectively 303, of the cross-section of said conducting bar 300.

According to a second embodiment, the thickness E2, measured at a first end 202 of the cross-section of a conducting bar 200, is greater than the thickness E3, measured at an opposite second end 203 of the cross-section of said conducting bar 200. FIG. 3 shows an example of this embodiment wherein a conducting bar 200 comprises two straight main faces 210,220. Given that the thicknesses E2 and E3 at the ends 202,203 are different, then at least one of the main faces 210,220 is not orthogonal to the main walls 14,15 of the enclosure 11.

A large number of alternative embodiments, some of which are represented in FIG. 3, concerning the shape of the cross-section S can be imagined in equivalent manner to obtain an increase of the form factor. A first alternative embodiment shows a conducting bar 300 that presents a cross-section a first main face 310 whereof is formed by two enlarged V-shaped parts 311 and 312, thus giving the cross-section of the bar 300 the shape of a pentagon with a maximum thickness E1 near to the centre. In FIG. 3, the parts 311 and 312 are flat and of identical size, but two parts 311 and 312 of different lengths could also be envisaged in equivalent manner.

In a second alternative embodiment, the cross-section of a conducting bar 500 can have a symmetrical shape with respect to a transverse axis X. This transverse axis X crosses the cross-section of said conducting bar 500 in a direction parallel to the width L of the bar. This alternative embodiment may be interesting in particular for intermediate conducting bars 30,40 of a busbar 10 none of the main faces whereof is facing the secondary walls 12,13 of the enclosure 11.

According to another alternative embodiment, the cross-section of a conducting bar 600,400 has a first main face of convex shape. In this case, this first main face can be either rounded 410 or polygonal 610.

In certain configurations, the cross-section of a conducting bar 20,300 comprises one of its main faces 22,320 that is straight and parallel to the transverse axis X, i.e. parallel to the secondary walls 12,13 of the enclosure 11. In this case, it is advantageous, in a busbar 10 with intermediate bars 30,40 situated between external bars 20,50 of a busbar 10, for said straight main face of the external bars 20,50 to be directed towards the outside of the enclosure 11 so as to be positioned facing the secondary walls 12,13 of the enclosure 11 that are also flat.

Modifying the shape of the cross-section S of a conducting bar can however lead to a reduction of the distance between conducting bars inside an enclosure 11 of the same dimension. This smaller distance may be penalising in particular if it no longer enables the necessary clearances between conducting bars to be respected. To avoid this drawback, it can then be envisaged for one of the main faces of a conducting bar 700 (see FIG. 3) to present a slight concavity 720 formed for example by a recess of rectangular, trapezoid or rounded shape. Thus, in the case where one of the main faces of an adjacent conducting bar presents a convex shape (with a thickness E1 greater than the thicknesses E2 and E3), this concavity 720 will enable this convexity to be compensated in order to increase the clearance distance between conducting bars, without changing the overall dimensions of the enclosure 11 of the busbar 10.

Due to one of the different shapes given to the cross-section of a conducting bar, at least one of the main faces is no longer orthogonal with respect to the main walls 14,15 of the enclosure 11, but presents an angle of inclination that leads to an increase of the form factor between the conducting bar and the main walls 14,15. The heat radiated by such a conducting bar when a current flows is therefore no longer directed directly to an adjacent conducting bar, but is partly diverted to the walls 14,15 of the enclosure 11, enabling a much better heat exchange between conducting bars and enclosure. This advantage then makes it possible, for an identical dimension of the busbar, i.e. in particular for a surface of cross-section S of the conducting bars identical to the surface of a cross-section S′, to make a much higher current flow in the electrical busbar 10 than in the electrical busbar 10′ according to the prior art.

For reasons of performances of the heat exchanges between the bars and the enclosure, it is obviously advantageous for all of the conducting bars of the same busbar to comply with the characteristics described in the present invention.

Furthermore, for reasons of simplification of manufacture and optimisation of costs, it may be preferable for all the conducting bars 20,30,40,50 of the same busbar 10 to have a cross-section S of identical shape, as represented in FIG. 2. As the conducting bar carrying the neutral N gives off less heat than the other conducting bars carrying a phase L1,L2,L3, it is preferable for this neutral conducting bar to be situated next to a phase conducting bar, the straight main face whereof shall be facing the neutral N to improve the heat exchanges. Thus, in the example of FIG. 2, the neutral bar N corresponds to the conducting bar 20 so that the adjacent conducting bar 30 (phase L1, for example) has its straight main face 32 situated facing the bar 20.

It is naturally possible to depart from the scope of the invention, to imagine other alternative embodiments and improvements to details and even to envision using equivalent means.

1. Electrical busbar for transportation and distribution of electrical power comprising several, rigid, parallel, metal electrical conducting bars, spaced out from one another inside a metal enclosure and separated from said metal enclosure, each conducting bar having an elongated cross-section with a first main face and a second main face, wherein the cross-section of at least one conducting bar of said electrical busbar is provided with a thickness near to the centre of said cross-section that is greater than the thickness of at least one of the ends of said cross-section.

2. Electrical busbar according to claim 1, wherein the cross-section of at least one conducting bar has a thickness near to the centre of said cross-section that is greater than the thicknesses at the two ends of said cross-section.

3. Electrical busbar according to claim 2, wherein the cross-section of at least one conducting bar has a first main face comprising two enlarged V-shaped parts.

4. Electrical busbar according to claim 2, wherein the cross-section of at least one conducting bar has a first main face of convex shape.

5. Electrical busbar according to claim 2, wherein the cross-section of at least one conducting bar has a first main face of polygonal convex shape.

6. Electrical busbar according to claim 1, wherein the cross-section of at least one conducting bar of said electrical busbar has a thickness at a first end of said cross-section that is greater than a thickness at an opposite second end of said cross-section.

7. Electrical busbar according to claim 6, wherein the cross-section of the conducting bar has two straight main faces.

8. Electrical busbar according to claim 1, wherein the cross-section of at least one conducting bar has a symmetrical shape with respect to a transverse axis passing through said cross-section of said conducting bar in a direction parallel to the width of said conducting bar.

9. Electrical busbar according to claim 1, wherein the cross-section of at least one conducting bar has a main face presenting a concavity.

10. Electrical busbar according to claim 1, wherein the cross-section of at least one conducting bar has a straight main face substantially parallel to a transverse axis passing through said cross-section of said conducting bar in a direction parallel to the width of said conducting bar.

11. Electrical busbar according to claim 10, having two external conducting bars surrounding one or more intermediate conducting bars, wherein the straight main face of the cross-section of the external conducting bars is directed towards the outside of the enclosure.

12. Electrical busbar according to claim 1, wherein all of the conducting bars of the busbar have a cross-section of identical shape.
